(19) United States
(12) Patent Application Publication
(10) Pub. No.: US 2013/0101383 A1
(43) Pub. Date: Apr. 25, 2013

(54) PORTABLE NON-MOTORIZED AUTOMATIC LIFT AND TRANSPORT APPARATUS FOR SMALL VEHICLES

(71) Applicants: Patrick Lynch, JR., New Braunfels, TX (US); Joseph Whitney, Dallas, TX (US); Richard Wilson, New Braunfels, TX (US)

(72) Inventors: Patrick Lynch, JR., New Braunfels, TX (US); Joseph Whitney, Dallas, TX (US); Richard Wilson, New Braunfels, TX (US)

(21) Appl. No.: 13/710,284

(22) Filed: Dec. 10, 2012

Related U.S. Application Data
(63) Continuation-in-part of application No. 12/456,157, filed on Jun. 10, 2009, now Pat. No. 8,327,979.
Application No. 12/456,157 is a continuation of application No. 11/891,189, filed on Aug. 10, 2007, now abandoned.

(51) Int. Cl. B66F 11/00

(52) U.S. Cl. CPC B66F 11/00
USPC 414/800; 187/240

(57) ABSTRACT

A portable, non-motorized automatic lift and transport apparatus allows users to lift and transport a small, powered vehicle with minimal physical exertion and without the need for secondary power source. The apparatus is comprised of a base and platform connected to a gear housing. The gear housing telescopically engages and moves vertically within a vehicle mount via a gear system. The drive wheels of the small, powered vehicle to be transported power the gear system attached to the gear housing to rotate the gear system and subsequently lift the to-be-transported vehicle using its own power source. A storage position is provided that can be used without disengaging a transmission. An alternate embodiment incorporates a worm gear and chain drive.

### CROSS-REFERENCE TO RELATED APPLICATIONS

This application is a Continuation-In-Part Application claiming priority benefit from U.S. patent application Ser. No. 12/456,157 filed Jun. 10, 2009 which claims priority benefit from U.S. patent application Ser. No. 11/891,189 filed on Aug. 10, 2007.

### FIELD OF THE INVENTION

The present invention relates to the lifting and transportation of personal motorized vehicles. In particular, the invention relates to a portable, non-motorized, automatic lift and transport apparatus that is mounted to a transport vehicle and is powered by the drive wheels of the lifted/transported personal vehicle.

### BACKGROUND OF THE INVENTION

Those who are physically challenged or have limited mobility often require the use of a motorized wheelchair or scooter for transportation. Sometimes the maximum distance of travel for these individuals is to the range of the motorized vehicle itself. Frequently, desired destinations are further from the person's home than the charge or fuel range of the motorized vehicle thus preventing the individual from reaching these destinations. A market, a park, or any location where the individual requires the aid of a wheelchair or scooter to sustain mobility or to access items they desire combined with the need to transport the wheelchair or scooter to the destination is out of reach. Without the ability to transport the motorized vehicle, the individual is basically stranded and often emotionally challenged and harmed through their immobility and limited lifestyle. Studies have indicated that personal mobility is directly correlated to mental and physical well being. Many users of motorized wheelchairs or scooters are on a fixed income and cannot necessarily afford the expense of a motorized lift and transportation apparatus in addition to the scooter itself thereby eliminating their ability to use such a wheelchair in locations where they may be of great need.

Additionally, other motorized vehicles such as All-Terrain Vehicles (ATV), riding lawnmowers, and self powered tillers often require transportation to locations where they can be of use.

An example of the prior art, U.S. Pat. No. 5,011,361 to Peterson, discloses a vehicle mountable carrier for three-wheeled scooters. The carrier includes a central support mast attachable to a motor vehicle at a trailer hitch. The mast requires a separate ball screw actuator operated by a DC motor connected to the electric system of the transport vehicle. The carrier moves a platform between a lowered and raised position. The carrier is specifically designed for three wheeled scooters and requires a separate motor connected to the carrier to operate.

U.S. Pat. No. 6,595,398 to Himel, Jr. discloses a vehicle mounted wheelchair rack for transporting a folded wheelchair. The rack integrates a jack assembly having a jack shaft and handle into a stationary frame coupled to the rear of the transportation vehicle. A telescoping member moves in a vertical casing upon actuation of the jack assembly. An alternate embodiment replaces the jack shaft and handle with a threaded screw rod rotatably coupled in the vertical casing. The lifting procedure of the Himel device is either by manual cranking of a jack handle or rotating the screw rod via a handle or powered drill.

U.S. Patent Application No. 2006/0093462 to Pradenas discloses an electrically powered threaded shaft mechanism attached to a standard scooter. A fixed support arm is mounted to the rear of a transportation vehicle via a trailer hitch. The scooter lifting mechanism uses a lifting motor and threaded shaft attached on the scooter itself to lift the scooter into position on the fixed support arm. The lifting mechanism uses the scooter's battery to supply electrical power to the lifting motor. The battery voltage must match the required voltage of the lifting motor and supply sufficient current to lift the vehicle. The scooter must be rotated into a vertical position on its rear wheels by lifting the front end of the scooter manually to attach the scooter to the fixed support arm connected to the transportation vehicle.

The prior art shows many versions of racks and trailers attached to vehicles for carrying other vehicles and wheelchairs. But problems arise when a user with limited mobility must load a motorized wheelchair or scooter onto such a rack or trailer without assistance. A rack that can easily lift and secure the scooter into a transportable position is desirable.

Therefore there is a need for an automatic lifting and transport system that does not require manual lifting, does not require a separate motor or an electrical power source, and is flexible enough to accommodate different, small-powered vehicles such as wheelchairs, scooters, riding lawnmowers, and ATVs.

One advantage of the disclosure of this apparatus is that the mechanical problems of present lift systems are alleviated. The apparatus does not require an independent power source or a power source matched to a drive motor. A further advantage is that the user of the apparatus does not have to perform any lifting. This is an important advantage, because the typical users of powered wheelchairs and scooters often are elderly or have limited mobility and are unable to perform strenuous physical activity. A further advantage over present lift systems is that manufacturing cost is substantially reduced because of the elimination of electrical motors and control systems required by the prior art. Still further, the disclosure is advantageous because it does not require a separate trailer and the complexity and maintenance necessitated by it.

### SUMMARY OF INVENTION

One preferred embodiment provides a portable, non-motorized automatic lift and transport apparatus for powered scooters and the like. The preferred embodiment requires neither extensive physical exertion nor external power sources. The preferred embodiment lifts and holds a small, self-powered vehicle and attaches it to a vehicle to destinations where it can be of use. The preferred embodiment relies on the motor and drive wheels of the transported vehicle to provide power to lift it.

Accordingly, an embodiment of the apparatus provides a frame for direct stable attachment to a transportation vehicle such as a car, truck, or RV. The frame supports a housing. The housing supports a threaded shaft nut for engagement with a threaded shaft. The threaded shaft is supported in a coupling unit which telescopes inside the housing. The threaded shaft includes a pinion gear rigidly attached to its lower end. The coupling unit is attached to a platform supporting the transported vehicle. The platform includes openings for the drive wheels of the transported vehicle. The transported vehicle is secured to the platform by a receiving mechanism. As the transported vehicle is secured to the platform, the drive wheels of the transported vehicle are engaged with a rotor bar supported by the frame. The rotor bar is supplied with a high friction surface and may further include high friction pads of different sizes to reduce slippage between the rotor bar and the drive wheels. The rotor bar is free to rotate about its central linear axis. The rotor bar includes a bevel gear for engagement with the pinion gear.

To lift and transport the powered vehicle, it is driven onto the platform. A coupling included on the underside of the powered vehicle engages the receiving mechanism and locks the vehicle into place on the platform. The drive wheels of the powered vehicle are engaged with the rotor bar and turn the rotor bar when activated. As the rotor bar turns, the gear on the rotor bar engages the pinion gear on the threaded shaft and turns it. As the threaded shaft rotates, the threaded shaft nut fixed in the vertical housing forces the threaded shaft, the coupling unit and attached platform upwards. To lower the powered vehicle, the drive wheels are rotated in the opposite direction and the process is reversed.

The disclosure provides a storage position. Actuator arms are provided which engage an actuator bar provided on the frame. The actuator arms tilt the frame upwards into a storage position. Lowering the platform reverses the motion.

An alternate preferred embodiment replaces the threaded shaft and the shaft nut setup with a worm gear and chain drive. The worm gear and chain drive are attached to a chain drive housing which is telescopically engaged with a vertical housing. The drive wheels of the transported vehicle engage a drive bar which in turn rotates a rotor bar and the worm gear.

Those skilled in the art will appreciate the above-mentioned features and advantages of the invention together with other important aspects thereof upon reading the detailed description that follows in conjunction with the drawings provided.

### BRIEF DESCRIPTION OF THE DRAWINGS

In the detailed description of the preferred embodiments presented below, reference is made to the accompanying drawings.

FIG. 1 is an isometric view of a preferred embodiment of the present disclosure.

FIG. 2 is an isometric view of the base of a preferred embodiment of the present disclosure.

FIG. 3 is an isometric view of the coupling unit and the vertical housing of a preferred embodiment of the present disclosure.

FIG. 4 is an isometric view of the rotor bar of a preferred embodiment of the present disclosure.

FIG. 5 is an exploded isometric view of a preferred embodiment of the present disclosure.

FIG. 6 is an isometric view of a preferred embodiment of the present disclosure in a stowed position.

FIG. 7 is a plan view of the coupling unit, threaded shaft, and vertical housing of a preferred embodiment of the present disclosure.

FIG. 8 is a plan view of a hand crank of a preferred embodiment of the present disclosure.

FIG. 9 is a cutaway side view of an alternate embodiment of a transmission of the present disclosure.

FIG. 10 is a partial plan view of an alternate embodiment of a transmission of the present disclosure.

FIG. 11 is a cutaway side view of an alternate embodiment of a transmission of the present disclosure.

FIG. 12 is an isometric view of an alternate embodiment of a transmission of the present disclosure.

FIG. 13 is an isometric view of an alternate embodiment of the present disclosure.

FIG. 14 is an isometric view of a chain drive housing of an alternate embodiment of the present disclosure.

FIG. 15 is a cutaway isometric view of a chain drive housing of an alternate embodiment of the present disclosure.

FIG. 16 an isometric view of the base of an alternate embodiment of the present disclosure.

FIG. 17 is an isometric view of an alternate embodiment of a transmission of the present disclosure.

### DETAILED DESCRIPTION OF THE PREFERRED EMBODIMENT

In the descriptions that follow, like parts are marked throughout the specification and drawings with the same numerals, respectively. The drawing figures are not necessarily drawn to scale and certain figures may be shown in exaggerated or generalized Bat in the interest of clarity and conciseness.

In one embodiment, lift and transport apparatus 100 is comprised of a vertical housing, a threaded shaft housing, a coupling unit, a base, a platform, a threaded shaft, and a rotor bar. Rotor bar 402 is mounted on platform 432. Platform 432 is connected to base 200 via weld or machine screws. Base 200 is pivotably connected to coupling unit 220. Coupling unit 220 is welded to or integrally formed with threaded shaft housing 250. Threaded shaft housing 250 encloses threaded shaft 404, extends vertically from coupling unit 220, and telescopically engages vertical housing 222. Vertical housing 222 is connected to a transportation vehicle via a trailer hitch insert or another common rigid connection known in the art.

Vertical housing 222 is formed of hollow steel square tubing approximately ⅛″ to ¼″×1½″ inch. Vertical housing 222 telescopically receives threaded shaft housing 250. Threaded shaft housing 250 and coupling unit 220 are formed of square steel tubing approximately ⅛″ to ¼″×1″ to ¼″.

Platform 432 is generally rectangular in shape and comprises two sections 440 and 442 separated by gap 444. Section 442 includes rectangular shaped cutouts 436 and 438. Additionally, section 442 includes insert hole 434. Platform 432 is formed of ⅛″ to ½″ aluminum plate. The plate may be drilled to reduce weight.

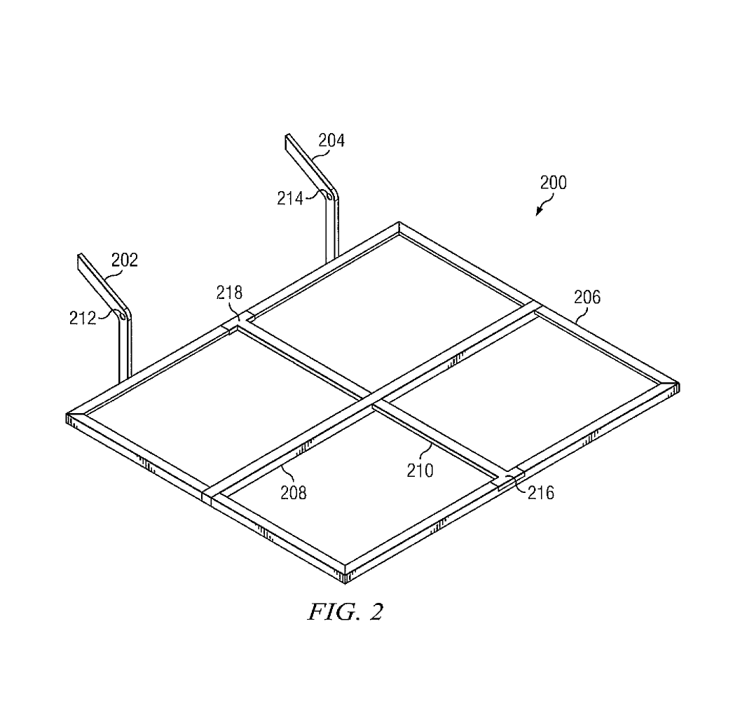

Referring to FIG. 2, base 200 is comprised of a rectangular shaped frame 206 having approximately the same dimensions as platform 432. Frame 206 further includes two crossmembers 208 and 210 intersecting perpendicularly for structural rigidity. Crossmember 210 includes mount points 216 and 218 at each end.

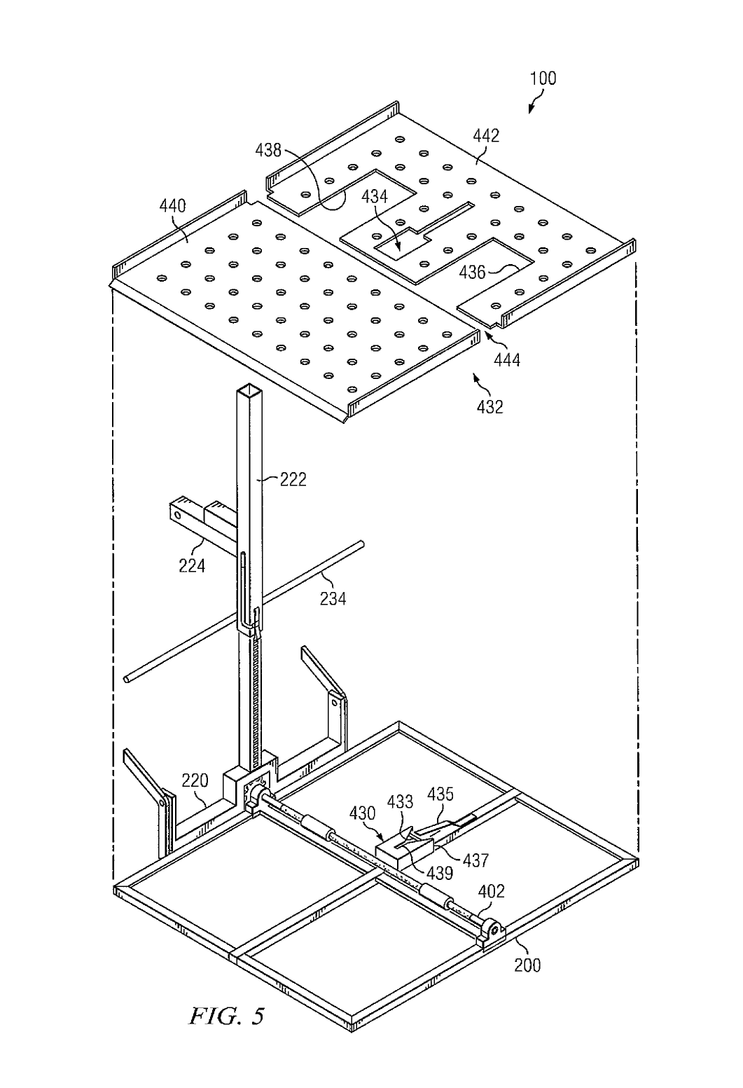

Insert 430 (shown in FIG. 5) is removably mounted near the midpoint of crossmember 208 with machine screws or permanently with a weld. Insert 430 includes latchbox 437 with guide slot 439. The open face of latchbox 437 includes locking bar 433, transversely mounted. Adjacent locking bar 433 is spring catch 435. Spring catch 435 is a resilient spring steel.

Returning to FIG. 2, frame 206 is preferably stainless steel angle of ¼″ to ½″ width. Crossmembers 208 and 210 are ¼″ to ½″ square steel tubing. Equidistant from mount point 218 and welded to one edge of frame 206 are tilt actuating bars 202 and 204. Tilt actuating bars 202 and 204 are ⅛″ to ½″ steel. Tilt actuating bars 202 and 204 include holes 212 and 214 respectively. Holes 212 and 214 are ¼″ to ½″ in diameter.

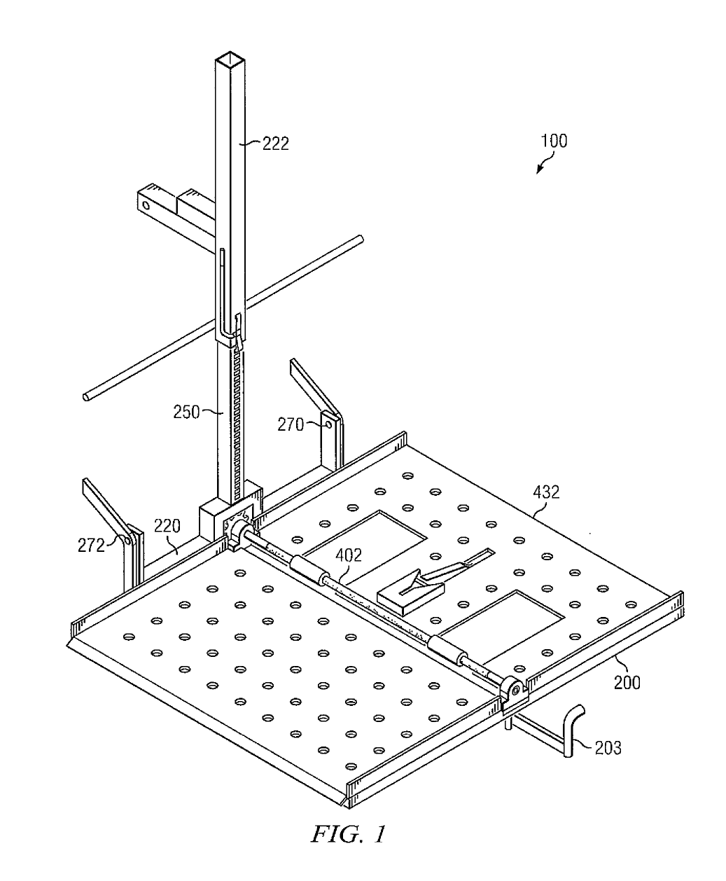

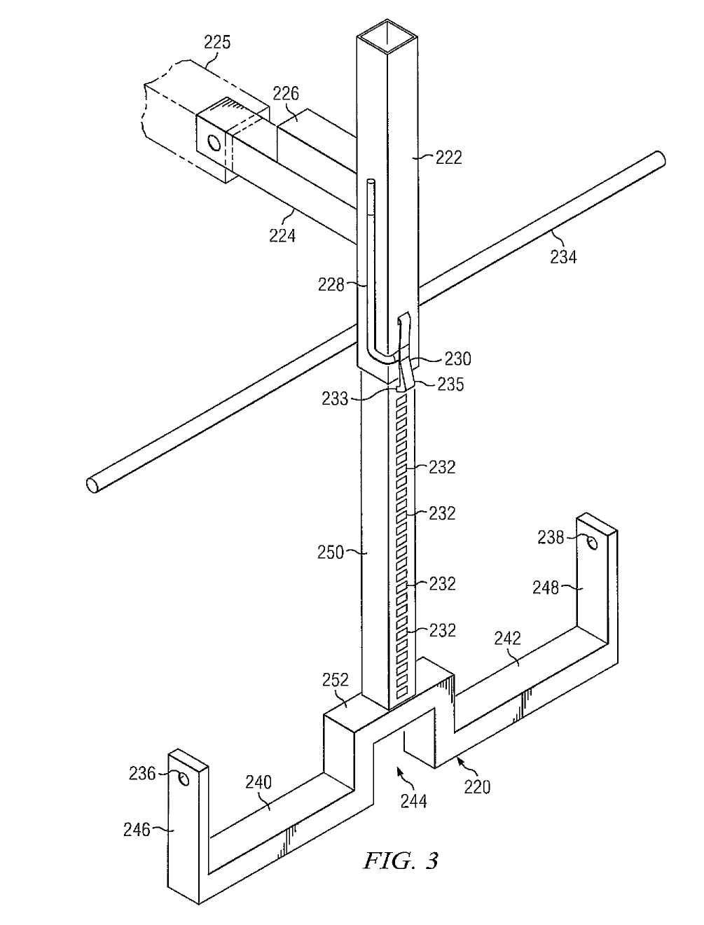

As shown in FIG. 3, coupling unit 220 is comprised of arms 240 and 242 separated by gap 244 and connected to each other by bridge 252. Opposite bridge 252, arm 240 includes flange 246 extending from arm 240 at approximately 90 degrees. Opposite bridge 252, arm 242 includes flange 248 extending approximately 90 degrees from arm 242. Flanges 246 and 248 are ⅛″ to ½″ steel integrally formed with or welded to coupling unit 220. Flanges 246 and 248 further include pivot holes 236 and 238 respectively. Pivot holes 236 and 238 are ¼″ to ½″ in diameter. Threaded shaft housing 250 extends approximately perpendicularly from coupling unit 220 from approximately the center of bridge 252. Threaded shaft housing 250 further includes a plurality of equally spaced, rectangularly shaped holes 232. Pins or screws concentrically align holes 212 and 214 with pivot holes 236 and 238 respectively and rotatably attach coupling unit 220 to base 200 with pins 270 and 272 (as shown in FIG. 1).

Hitch insert 224 extends from vertical housing 222 approximately perpendicularly. Hitch insert 224 is integrally formed with or is welded to vertical housing 222. Hitch insert 224 interfaces with hitch receiver 225 which is permanently affixed to a transportation vehicle. Hitch received 225 shown in shadow is well known in the art. Support 226 is adjacent hitch insert 224 and vertical housing 222. Support 226 is welded to hitch insert 224 and vertical housing 222 for added strength. Vertical housing 222 also includes actuating bar 234. The midpoint of actuating bar 234 is welded to the vertical housing underneath hitch insert 224 at approximately a right angle with the vertical housing. Actuating bar 234 extends from two sides of vertical housing 222. Actuating bar 234 is a ½″ diameter steel bar and is approximately 24″ in length.

Vertical housing 222 further includes handle 228 and latch 230. Latch 230 is comprised of spring steel spot welded to the outside of vertical housing 222. Latch 230 includes an angled latch head 235. Angled latch head 235 includes ratchet surface 233. Ratchet surface 233 and holes 232 form a ratchet and pawl mechanism designed to allow vertical travel of vertical housing 222 in an upward direction only. Handle 228 is attached to latch 230 at approximately a midpoint. Handle 228 and latch 230 combine with holes 232 to provide a safety-locking feature.

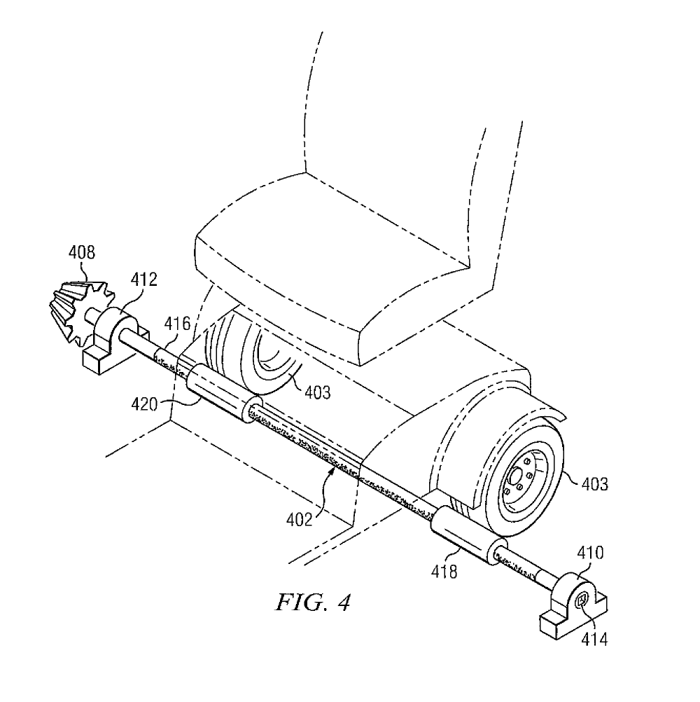

Rotor bar 402 is shown in FIG. 4. Rotor bar 402 is a 1″ diameter steel bar having a length exceeding the length of crossmember 210. Rotor bar 402 is supported in mounts 410 and 412 with roller bearings. Mounts 410 and 412 are attached to base 200 at mount points 216 and 218 respectively with ¼″ to ½″ steel bolts. Mount 410 includes square socket insert 414. Rotor bar 402 includes high friction surface 416. In a preferred embodiment, wheel pads 418 and 420 are affixed to rotor bar 402. Wheel pads 418 and 420 are aligned with cutouts 436 and 438, respectively. The wheel pads of the preferred embodiment comprise flexible neoprene cylinders affixed to the rotor bar with a suitable adhesive. Different outside diameters of wheel pads are provided. FIG. 4 also shows drive wheels 403 of the scooter 411 (shown in shadow) adjacent wheel pads 420.

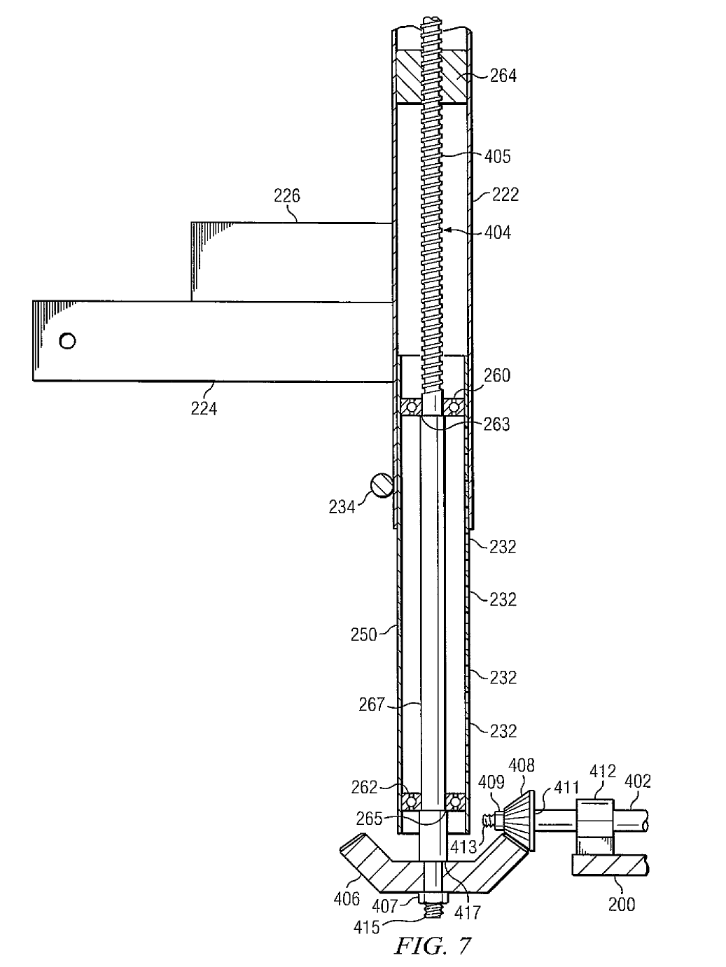

FIG. 7 shows a cutaway view of vertical housing 222, threaded shaft housing 250 and transmission components. Threaded shaft 404 is a ½″ to 1″ diameter steel rod approximately 36″ in length. Threaded shaft 404 includes threaded section 405. Threaded section 405 includes threads with a pitch of about 3 degrees. Threads of pitch between 2° and 10° have been found to function correctly. Other pitch angles will function. Lower pitch threads are employed in higher weight applications as will be understood by those in the art. Threaded shaft 404 includes thumb-threaded section 267, shoulder 263 and shoulder 265. Shoulder 263 is a larger diameter than the diameter of threaded section 405 and supports inner race of bearing 260. Shoulder 265 is a slightly larger diameter than unthreaded section 267 and supports the inner race of bearing 262.

Threaded shaft 404 includes shoulder 417. Pinion gear 406, abuts shoulder 417 and is held in place by nut 407 engaging threads 415. Relative rotation between pinion gear 406 and threaded shaft 404 is prevented by a key way or flat, as known in the art. Threaded shaft 404 includes pinion gear 406 attached at its end. Pinion gear 406 includes approximately 80 teeth at 10 pitch. Bevel gear 406 has a diameter of approximately 2″. The longitudinal axes of vertical housing 222, threaded shaft housing 250, and threaded shaft 404 are concentric. Threaded shaft 404 is free to rotate in threaded shaft housing 250. Bearings 260 and 262 are fixed inside threaded shaft housing 250. Bearings 260 and 262 allow threaded shaft 404 to rotate and move vertically and additionally fix the position of threaded shaft 404 horizontally relative to threaded shaft housing 250. Threaded shaft 404 rotates in threaded shaft nut 264. Threaded shaft nut 264 is fixed inside vertical housing 222. Threaded shaft nut 264 mates with threaded shaft 404. Thus as threaded shaft 404 rotates, it advances through threaded shaft nut 264.

Rotor bar 402 further includes bevel gear 408 located on the end of the rotor bar proximate mount 412. Bevel gear 408 engages pinion gear 406. Bevel gear 408 includes approximately 20 teeth at 10 pitch. Of course other numbers of teeth and pitches will function. The ratio between the pinion gear and the bevel gear provides for an increase in torque at the base of the threaded rod and to provide additional lifting force.

Rotor bar 402 supports bevel gear 408 through shoulder 411. Rotor shaft 402 includes threaded section 413. Nut 409 mates with threads 413 and holds bevel gear 408 adjacent shoulder 411. Relative rotation between bevel gear 408 and rotor shaft 402 is prevented through the use of a key way (not shown) or flat, as known in the art.

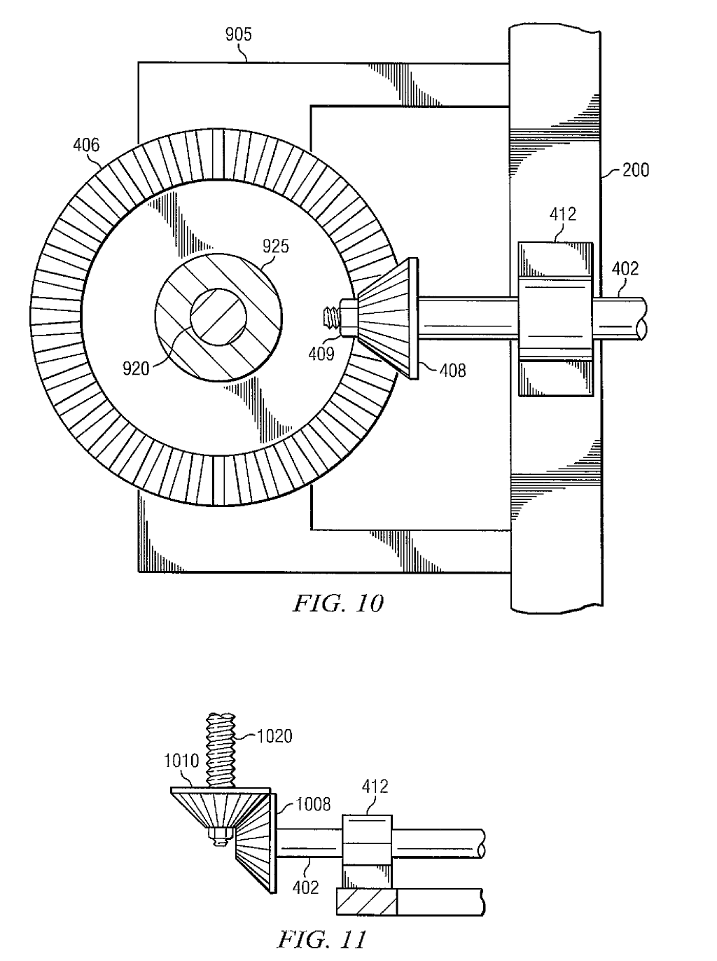

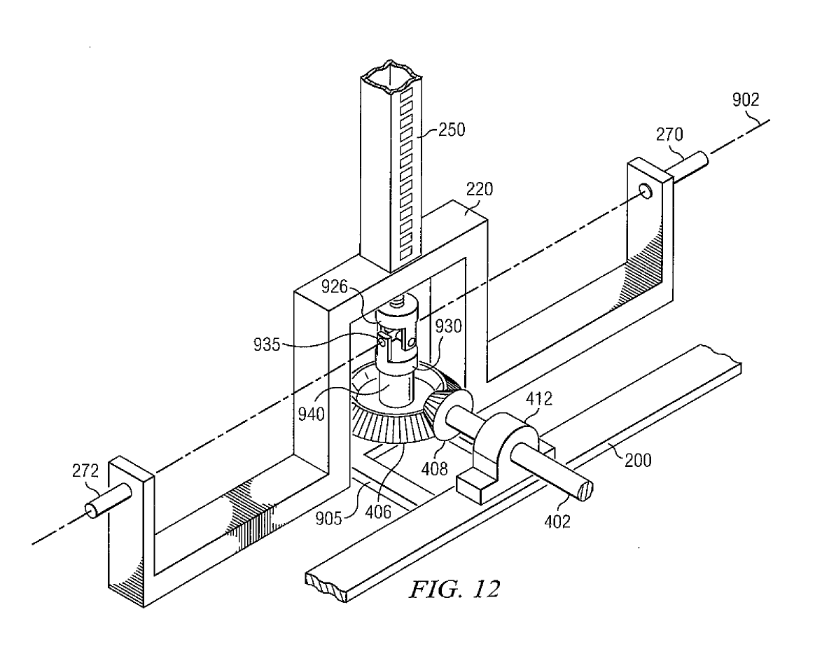

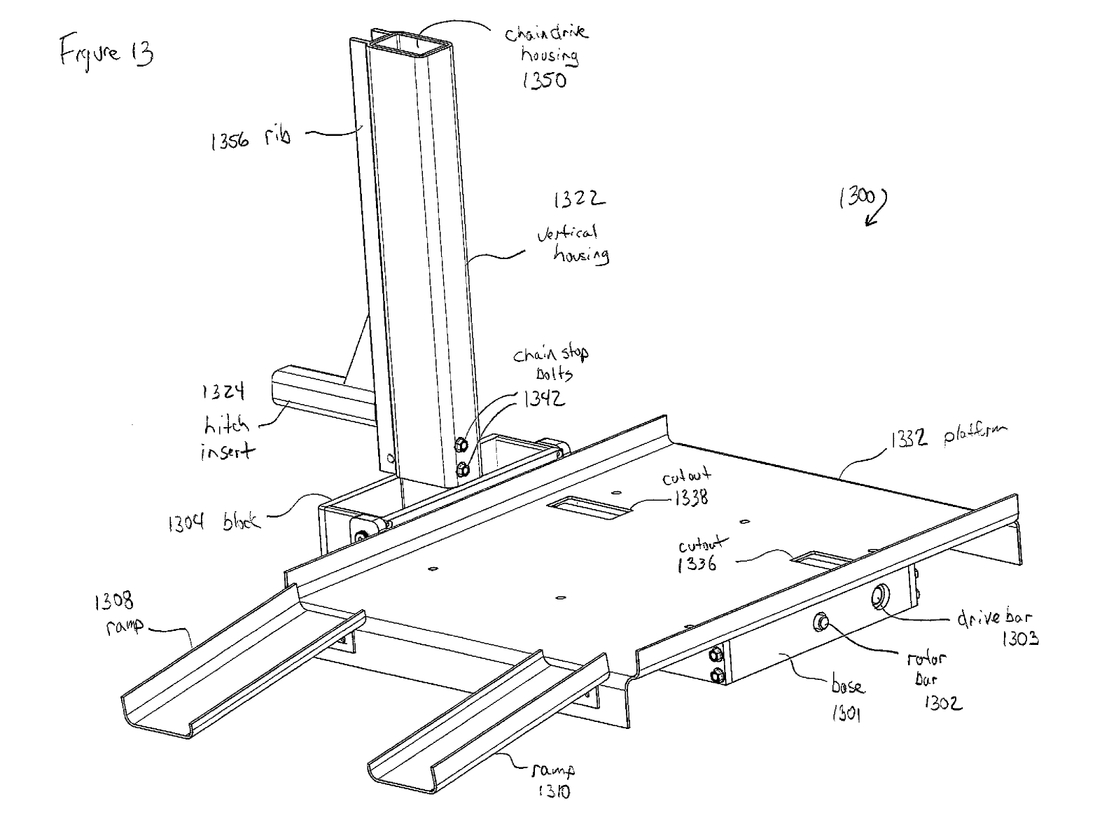

Referring to FIGS. 9, 10 and 12, an alternate embodiment of the transmission system of the disclosure is provided. Threaded rod 920 is attached to universal joint 925 at upper half 926. Upper half 926 is connected to lower half 930 with crossmember 935. Lower half 930 of universal joint 925 is connected to extension shaft 940. Extension shaft 940 includes shoulder 985, threaded section 945, reduced diameter section 980, and threaded section 975. Pinion gear 406 is held adjacent shoulder 985 by nut 965 threaded onto threaded section 945. Relative rotation between pinion gear 406 and extension shaft 940 is prevented by key way 960, pinion slot 955 and slot 950. Those skilled in the art will appreciate that universal joint 925 may be replaced by a constant velocity joint or flexible coupling as known in the art.

Bearing 910 is provided adjacent shoulder 990 and held in place by nut 915 on threaded section 975. Threaded section 975 has a diameter less than threaded section 945. Diameter of threaded section 945 is less than the diameter of extension shaft 940. Bearing 910 is seated within support frame 905. Support frame 905 is welded to the bottom of base 200.

Importantly, the plane 902 formed by crossmember 935 when it is perpendicular to the axis of threaded rod 920 and extension shaft 940, must pass through the line formed by the axis of pin 272 and pin 270, thereby allowing pinion gear 406, bevel gear 408 and support frame 905 and their associated components to rotate upwards around the axis of pin 272 and pin 270 while both rotor bar 402 and threaded rod 920 are turning.

Referring now to FIG. 11, an alternate embodiment of the transmission system of the disclosure is provided. Miter gear 1010 is affixed to one end of threaded rod 1020. Miter gear 1010 has an upper diameter that is greater than its lower diameter. Miter gear 1008 is affixed to one end of rotor bar 402 which is rotationally supported in mount 412. Mount 412 is mounted to base 200. Miter gear 1008 engages miter gear 1010 from below. An example of miter gears 1008 and 1010 are 10 pitch, 20 teeth miter gears from Boston Gear of Charlotte, N.C.

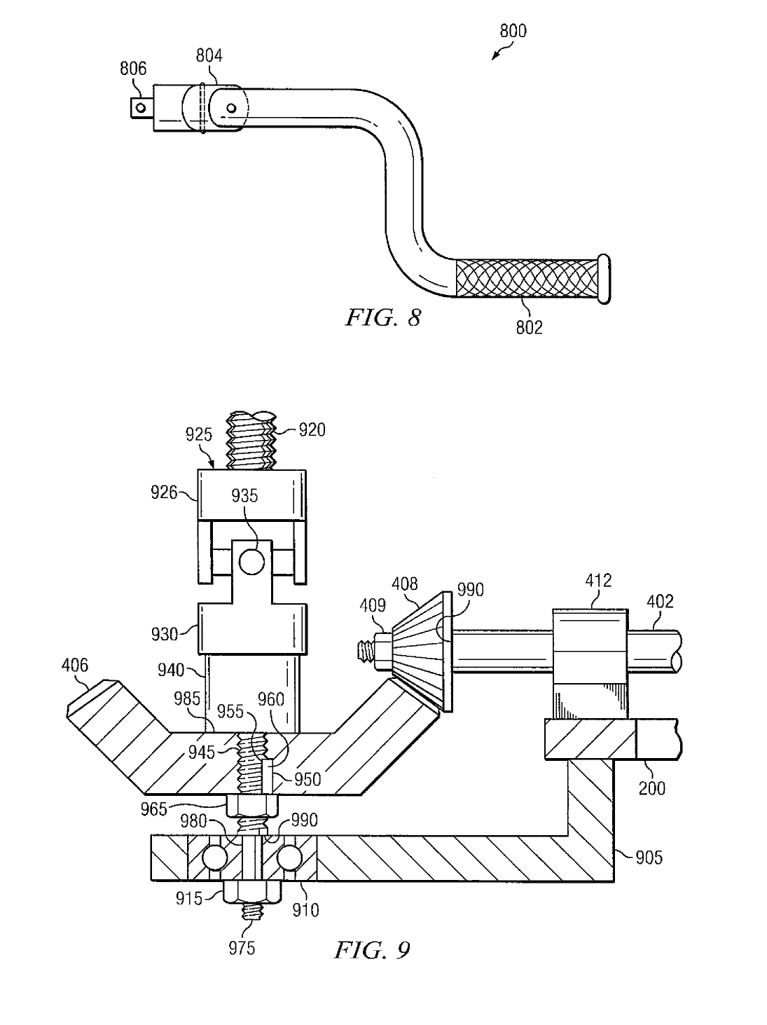

FIG. 8 depicts hand crank 800. Hand crank 800 is comprised of handle 802, gimbal 804, and ratchet head 806. Hand crank 800 is a 1″ diameter steel rod approximately 18″ in length and bent or rolled to have two opposite 90 degree bends. Handle 802 is proximate one end of hand crank 800 and gimbal 804 is pinned to the opposite end. Gimbal 804 is free to rotate about the axis of its pin approximately 180 degrees. Ratchet head 806 is pinned to gimbal 804. Ratchet head 806 is free to rotate approximately 180 degrees about the axis of its pin. Ratchet head 806 is sized to engage socket insert 414.

In use, lift and transport apparatus 100 may be mounted to a transportation vehicle via a standard trailer hitch. Other methods of rigid connection are possible. In a preferred embodiment, hitch insert 224 engages the trailer hitch on the transportation vehicle and is secured by a hitch lock and pin as is common in the art. Lift and transport apparatus 100 translates between three positions. The first position is the “loading” position, the second position is the “loaded” position, and third position is the “stored” position.

FIG. 1 shows lift and transport apparatus 100 in the “loading” position. Base 200 is adjacent the surface of the ground. The powered vehicle to be transported, such as a scooter, drives on to platform 432 via section 442. A transportation hook mounted on the scooter (not shown) engages insert 430 and locks the scooter into place. As the scooter becomes locked into insert 430, the drive wheels of the scooter move through cutouts 436 and 438 and become adjacent to and are tightly pressed against wheel pads 418 and 420. Apparatus 100 is designed to incorporate multiple sizes and shapes of powered vehicles, it may be necessary to change or remove wheel pads 418 and 420 to accommodate different sized drive wheels.

The motor and drive wheels of the scooter provide the power to raise the lift and transport apparatus with the scooter secured on the platform into the “loaded” position. Once the scooter is fully engaged with insert 430, secured into place, and the drive wheels are adjacent rotor bar 402, the drive wheels of the scooter (not shown) are activated. The drive wheels of the scooter rotate rotor bar 402. As rotor bar 402 rotates, bevel gear 408 rotates. The rotation of bevel gear 408 consequently rotates pinion gear 406 and threaded shaft 404. Bearings 260 and 262 allow threaded shaft 404 to rotate within threaded shaft housing 250. Consequently, helical drive nut 264 allows threaded shaft 404 to advance through vertical housing 222. As a result of the force of bearings of 260 and 262 on shaft housing 250, coupling unit 220, base 200, and platform 432 all move vertically. Threaded shaft housing 250 slides telescopically inside vertical housing 222, thereby raising the attached scooter. When proper ground clearance is reached, the drive wheels of the scooter are deactivated. Latch 230 is engaged in the plurality of holes 232 thereby preventing unintended movement.

To unload the scooter, handle 228 is used to unlock latch 230 and the scooter's drive wheels are rotated in the opposite direction. Once base 200 is resting on the ground surface, the scooter is disengaged from insert 430 and driven off platform 432.

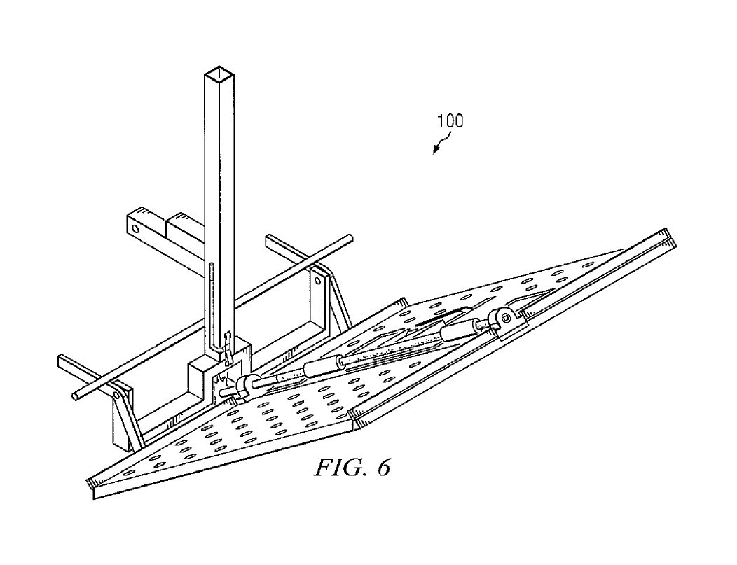

The third position or the “stored” position is shown in FIG. 6. When lift and transport apparatus 100 is not in use it is desirable to store the apparatus in a convenient and space saving manner. As the drive wheels of a transported vehicle are unavailable, hand crank 800 is used to rotate rotor bar 402 by hand. Ratchet head 806 is inserted into socket insert 414. Gimbal 804 allows hand crank 800 to rotate while hand crank 800 is engaged with socket insert 414 at varying angles. Hand crank 800 rotates rotor bar 402 which in turn rotates bevel gear 408. Bevel gear 408 as a result of its engagement with pinion gear 406 rotates pinion gear 406 and threaded shaft 404. Threaded shaft 404 engages helical drive nut 264 and threaded shaft 404, threaded shaft housing 250, coupling unit 220, base 200, and platform 432 rise vertically. Threaded shaft 404, threaded shaft housing 250, coupling unit 220, base 200, and platform 432 rise vertically until actuating bars 202 and 204 come in contact with actuating bar 234. As the actuating bars contact actuating bar 234, base 200 and platform 432 begin to pivot upward around pivot pins 270 and 272. The higher the base and platform are raised via rotating the hand crank, the more they will pivot until they reach a maximum angle of approximately 45°. At this point, bevel gear 408 disengages from pinion gear 406. The base and platform are then moved to a completely vertical orientation manually. When base 200 is in a vertical position, lock 403 is rotated into position behind vertical housing 222.

In the case of the alternate embodiment, as rotor bar 402 rotates, bevel gear 408 rotates pinion gear 406. Pinion gear 406 in turn rotates transition shaft 940 and universal joint 925 thereby rotating threaded rod 920. As base 200 is lifted, actuator arms 202 and 204 engage actuating bar 234 thereby rotating base 200 upward about pivot pins 270 and 272. As a result, support frame 905 rotates upward, thereby moving the entire transmission upward and changing the angle between the axis of transition bar 940 and threaded rod 920. The process continues until a “stored position” of between 45° and 60° is reached.

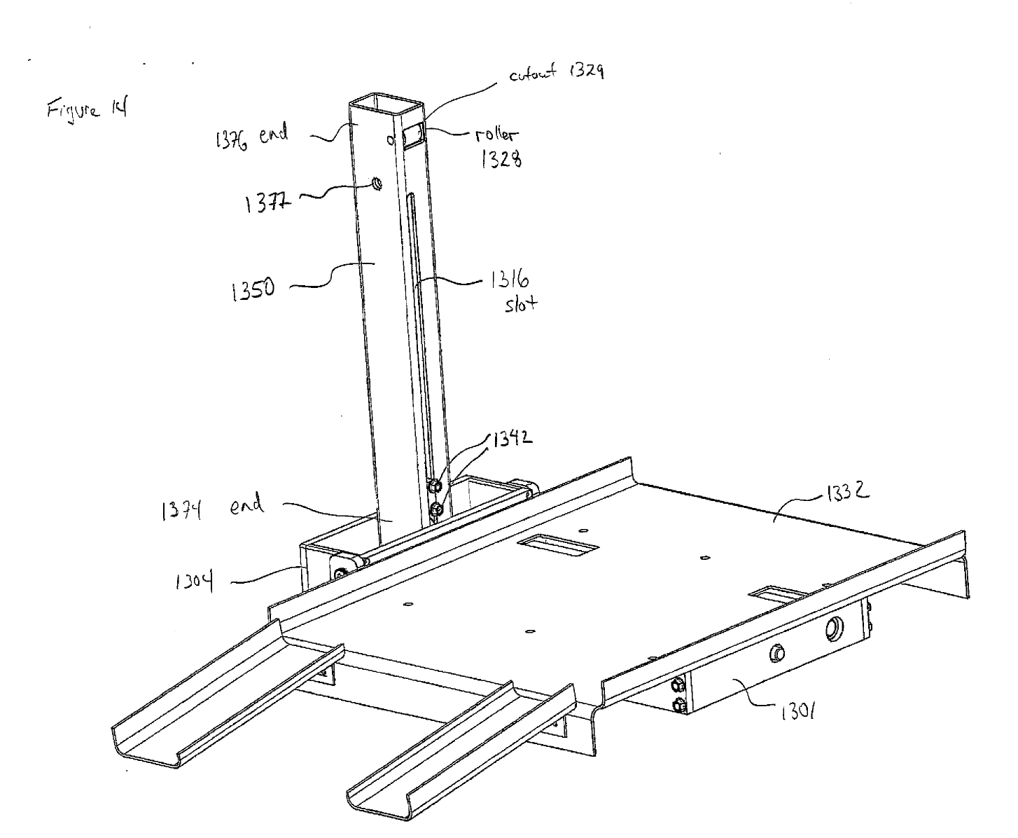

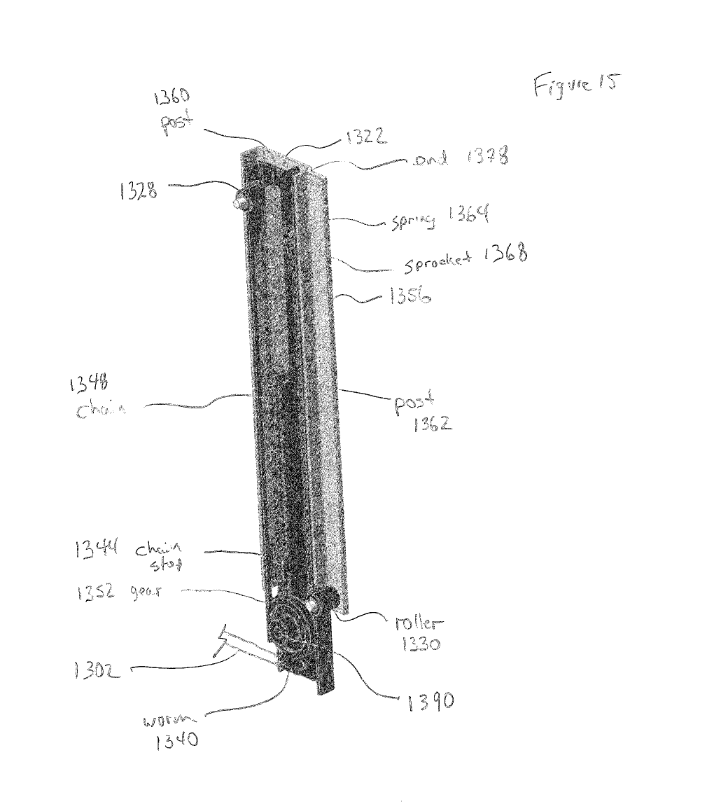

In an alternate embodiment shown in FIGS. 13 and 14, lift and transport apparatus 1300 is comprised of vertical housing 1322, chain drive housing 1350, block 1304, base 1301, and platform 1332. Platform 1332 is connected to base 1301 by welding or with screws. Base 1301 is pivotably connected to block 1304. Chain drive housing 1350 is connected to block 1304 via weld or machine screws. Chain drive housing 1350 extends vertically from block 1304 and telescopically engages vertical housing 1322. Vertical housing 1322 includes rib 1356 for connection to a transportation vehicle via hitch insert 1324 or other common rigid connection known in the art.

Platform 1332 is generally rectangular in shape and includes rectangular shaped cutouts 1336 and 1338. Platform 1332 is formed of ⅛″ to ½″ aluminum plate. Ramps 1308 and 1310 are removably connected to platform 1332. Ramps 1308 and 1310 allow easy access for a transported vehicle to platform 1332. Drive bar 1303 and rotor bar 1302 are supported by roller bearings mounted in base 1301. Cutouts 1336 and 1338 are aligned with drive bar 1303 such that drive bar 1303 is exposed to and comes in contact with the drive wheels of the transported vehicle through cutouts 1336 and 1338.

Chain drive housing 1350 has end 1374 attached to block 1304. Cutout 1329 is a rectangular shaped hole located at end 1376 of chain drive housing 1350. Roller 1328 is cylindrically shaped and partially extends through cutout 1329. Roller 1328 is mounted to chain drive housing 1350 and is free to rotate about its central axis. Roller 1328 is adjacent vertical housing 1322 and aligns chain drive housing 1350 with respect to vertical housing 1322 as chain drive housing 1350 telescopically engages with and slides within vertical housing 1322. Slot 1316 is an oblong opening beginning at end 1374 running nearly the length of chain drive housing 1350 stopping short of cutout 1329. Chain stop bolts 1342 affix chain stop 1344 to chain 1348. Chain stop bolts 1342 extend through slot 1316. The shafts of chain stop bolts 1342 slide within slot 1316. The heads of chain stop bolts 1342 are adjacent to and tightened against the exterior of vertical housing 1322. The position of chain stop bolts 1342 and chain stop 1344 relative to vertical housing 1322 is not altered during operation of lift and transport apparatus 1300.

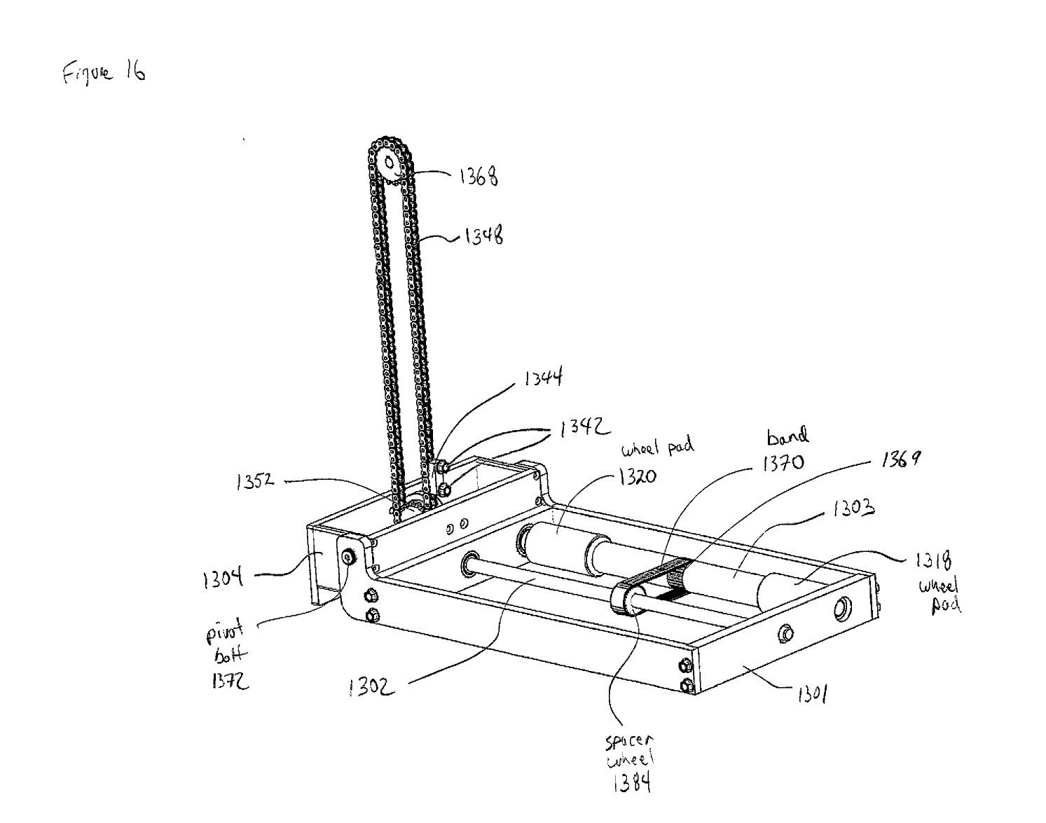

Referring to FIG. 15, a cutaway view of chain drive housing 1350 is shown telescopically engaged with vertical housing 1322. Gear 1352 is rotatably mounted to chain drive housing 1350 at end 1374 by pin 1390. Gear 1352 is engaged with worm 1340. Worm 1340 is attached to an end of rotor bar 1302. Chain 1348 engages gear 1352 and sprocket 1368. Sprocket 1368 is rotatably mounted to chain drive housing 1350 at end 1376 by pin 1377. The location of chain stop 1344 relative to chain 1348 does not change as chain stop 1344 is rigidly affixed to chain 1348. Post 1362 is connected to and extends generally perpendicularly from the interior of chain drive housing 1350. Post 1362 is located near the midpoint of the length of chain drive housing 1350. Post 1360 is connected to and extends generally perpendicularly from the interior of vertical housing 1322. Post 1360 is located at end 1378 of vertical housing 1322. Spring 1364 is a coil spring connected to post 1360 and post 1362. Spring 1364 urges chain drive housing 1350 into vertical housing 1322. Roller 1330 is cylindrically shaped and is mounted to rib 1356 near gear 1352. Roller 1330 is free to rotate about its central axis. Roller 1330 is adjacent chain drive housing 1350 and aligns chain drive housing 1350 with respect to vertical housing 1322 as chain drive housing 1350 telescopically engages with and slides within vertical housing 1322.

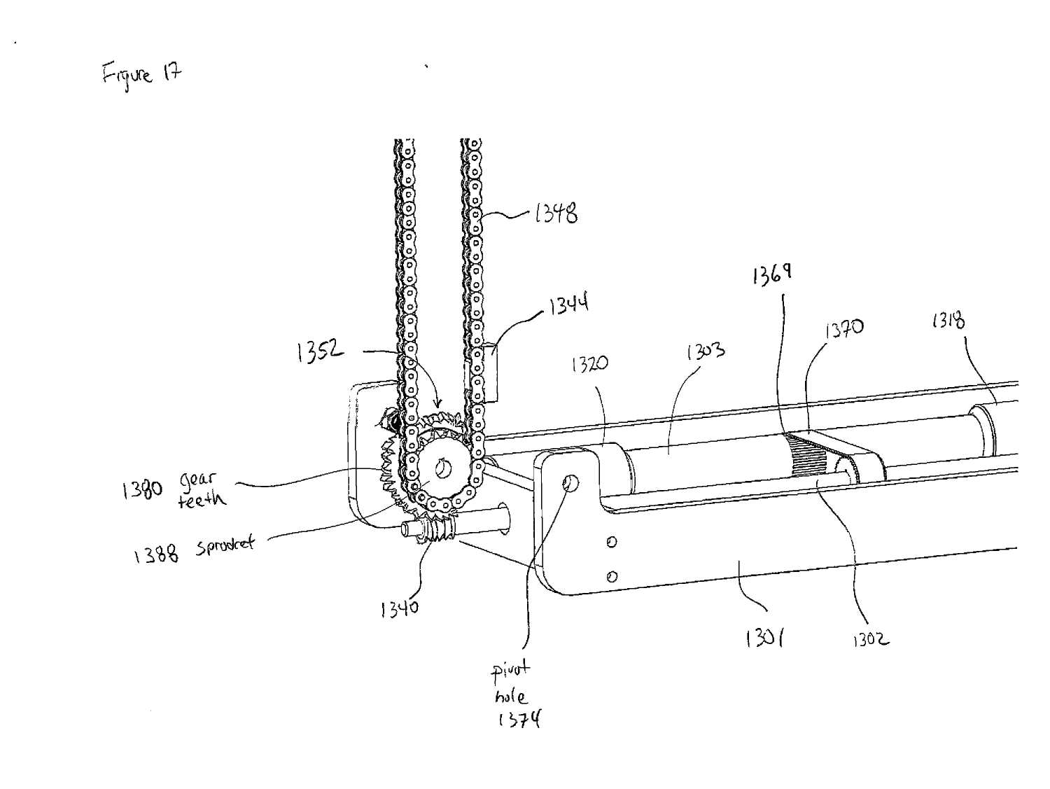

Referring now to FIG. 16, drive bar 1303 and rotor bar 1302 are rotatably supported with bearings mounted in base 1301. Drive bar 1303 and rotor bar 1302 are generally parallel to each other and generally perpendicular to chain drive housing 1350. Base 1301 is pivotally mounted to block 1304 with pivot bolts 1372 in pivot holes 1374. Wheel pads 1318 and 1320 are affixed to drive bar 1303. Wheel pads 1318 and 1320 are aligned with cutouts 1336 and 1338, respectively. In one embodiment, the wheel pads are comprised of flexible neoprene cylinders affixed to the drive bar with a suitable adhesive. Different outside diameters of wheel pads are envisioned. Different materials can be used. Knurling drive bar 1303 will also suffice. Notched belt 1370 loops around both drive bar 1303 and rotor bar 1302. Rotation of drive bar 1303 causes simultaneous rotation of rotor bar 1302. Drive bar 1303 includes a notched surface 1369 which engages notched belt 1370. Notched sprocket 1384 is affixed to rotor bar 1302. Notched sprocket 1384 engages notched belt 1370. Different sized notched sprockets may be used in order to alter the ratio of rotational speeds between drive bar 1303 and rotor bar 1302. Ratios of 1:2, 1:3, and 1:5 are envisioned. The notched belt, notched sprocket, and notched surface may be replaced by a pair of sprockets and a chain in an alternate embodiment.

As shown in FIG. 17, rotor bar 1302 extends from base 1301 into block 1304. Worm 1340 is affixed to the end of rotor bar 1302 extending into block 1304. Worm 1340 includes threads which engage gear 1352. Gear 1352 includes gear teeth 1380 which engage the threads of worm 1340. Gear 1352 further includes sprocket 1388. Sprocket 1388 engages chain 1348.

In use, lift and transport apparatus 1300 may be mounted to the transportation vehicle via a standard 2″ receiver, Other sizes can be used. Other rigid connection will suffice. Hitch inset 1324 engages the receiver of the transportation vehicle and is secured by a hitch pin or other connection means common in the art.

To load the transported vehicle, lift and transport apparatus 1300 must be in a lowered position. In the lowered position, base 1301 is adjacent the surface of the ground. Chain drive housing 1350 is extended from vertical housing 1322 and chain stop 1344 is at end 1376. The vehicle to be transported is driven onto platform 1332 by use of ramps 1308 and 1310 until the drive wheels of the transported vehicle become adjacent to wheel pads 1318 and 1320 extending through cutouts 1336 and 1338. Lift and transport apparatus 1300 can incorporate different sizes of transported vehicles by altering the size of cutouts 1336 and 1338 and changing or removing wheel pads 1318 and 1320. The transported vehicle is secured to the platform via a hook and insert as previously described or other connection means common in the art.

The motor and drive wheels of the transported vehicle provide the power to raise lift and transport apparatus 1300 with the transported vehicle secured thereon into a raised position. The drive wheels of the transported vehicle rotate drive bar 1303 in a first direction. The rotation of drive bar 1303 simultaneously rotates rotor bar 1302 as a result of their connection via notched belt 1370. The rotation of rotor bar 1302 rotates worm 1340. The rotation of worm 1340 consequently rotates gear 1352 and sprocket 1388.

As viewed from the perspective of FIG. 17, a clockwise rotation of gear 1352 moves chain stop 1344 from end 1376 to end 1374 through the length of slot 1316 and thus raises the platform as chain drive housing 1350 slides in to vertical housing 1322. Because chain stop 1344 is fixed in relation to vertical housing 1322, moving chain stop 1344 from end 1376 to end 1374 raises chain drive housing 1350 up in vertical housing 1322. As chain drive housing 1350 rises, connected block 1304 rises as well as base 1301 and platform 1342. When proper ground clearance is reached, the drive wheels of the transported vehicle are deactivated.

As viewed from the perspective of FIG. 17, a counter-clockwise rotation of gear 1352 moves chain stop 1344 from end 1374 to end 1376 and thus lowers the platform as chain drive housing 1350 extends from vertical housing 1322 until base 1301 is adjacent the ground. Once unsecured, the transported vehicle is free to drive off platform 1332.

During the raising and lowering of chain drive housing 1350 and the connected platform, vertical housing 1322 and chain stop 1344 do not move relative to the transportation vehicle. Vertical housing 1322 is fixed to the trailer hitch of the transportation vehicle and chain stop 1344 is fixed to vertical housing 1322. As chain drive housing 1350 slides telescopically within vertical housing 1322, rollers 1328 and 1330 guide the movement.

When not in use and when a transported vehicle is not secured thereon, platform 1342 may be pivoted about pivot bolts 1372 to a stored position so that platform 1342 is flush with vertical housing 1322. Common connections known in the art secure the platform to the vertical housing.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

1. An apparatus for lifting and transporting a powered vehicle having a set of drive wheels, wherein the apparatus is attached to a receiver of a transportation vehicle, the apparatus comprising:
a vertical housing connected to the receiver;
a chain drive housing telescopically engaged with the vertical housing;
a base pivotally connected to the chain drive housing:
a platform affixed to the base;
a rotor bar rotatable within the base;
a worm attached to the rotor bar;
a gear with a set of teeth and a first sprocket, where the worm engages the set of teeth;
the first sprocket and a second sprocket connected by a chain;
a chain stop rigidly affixed to the chain and to the vertical housing; and,
whereby when the drive wheels are activated, the base and the platform are moved.

2. The apparatus of claim 1 further comprising:
a drive bar rotatable within the base and generally parallel with the rotor bar; and,
a belt engaged with the drive bar and the rotor bar.

3. The apparatus of claim 2 further comprising;
a set of variably sized wheel pads affixed to the drive bar; and,
a set of openings in the platform aligned with the wheel pads.

4. The apparatus of claim 3 wherein the set of wheel pads comprise flexible neoprene cylinders.

5. The apparatus of claim 2 further comprising a variably sized spacer wheel affixed to the rotor bar and frictionally engaged with the band.

6. The apparatus of claim 1 further comprising:
a slot in the chain drive housing extending from a first end to a second end;
a set of bolts rigidly affixing the chain stop to the chain and the vertical housing,
whereby the set of bolts extend through the slot and move through the length of the slot between the first end and the second end.

7. The apparatus of claim 6 further comprising:
a first post connected to the vertical housing adjacent the first end;
a second post connected to the chain drive housing approximately midway between the first end and the second end; and,
a coil spring attached to the first post and the second post.

8. The apparatus of claim 1 wherein when the base and platform are moved, the position of the chain stop relative to the vertical housing is not altered.

9. The apparatus of claim 1 wherein the base is pivoted to a stored position so that the platform is adjacent the vertical housing.

10. The apparatus of claim 1 further comprising:
a first roller attached to the vertical housing and adjacent the chain drive housing; and,
a second roller attached to the chain drive housing and adjacent the vertical housing.

11. The apparatus of claim 1 further comprising:
a drive bar rotatable within the base and generally parallel with the rotor bar;
a third sprocket affixed to the drive bar and a fourth sprocket affixed to the rotor bar; and,
a chain engaging the third sprocket and the fourth sprocket.

12. A lift and transport apparatus for raising and moving a powered scooter having a set of drive wheels, the apparatus engaged with a transportation vehicle and comprising:
a receiver removably engaged with the transportation vehicle;
a vertical hollow body attached to the receiver and further including a rib;
a chain housing telescopically engaged with the vertical hollow body and rigidly affixed to a stand;
a base pivotably attached to the stand and rigidly connected to a platform;
a drive bar and a rotor bar, generally parallel to each other and perpendicular to the chain housing, each rotatably supported in the base;
a belt engaged with the drive bar and the rotor bar;
a gear rotatably attached to the chain housing at a first end where the gear includes a set of teeth and a first sprocket;
a second sprocket rotatably attached to the chain housing at a second end;
a chain engaged with the first sprocket and the second sprocket;
a dog rigidly affixed to the chain by a set of chain bolts;
a slot in the chain housing extending from the first end to the second end where the set of chain bolts extend through the slot and affix the chain stop to the vertical hollow body;
a worm gear affixed to the rotor bar where the rotor bar extends from the base into the stand, wherein the worm gear engages the set of teeth;
wherein the drive bar is frictionally engaged with the set of drive wheels;
whereby when the drive wheels are rotated in a first direction, the platform is raised and when the drive wheels are rotated in a second direction, the platform is lowered.

13. The apparatus of claim 12 further comprising:
a first roller attached to the rib at the first end and adjacent the chain housing; and,
a second roller attached to the chain housing at the second end and adjacent the vertical hollow body.

14. The apparatus of claim 12 further comprising:
a first post attached to the chain housing approximately midway between the first end and the second end and a second post attached to the vertical hollow body adjacent the second end; and,
a spring, attached to the first post and the second post, biasing the chain housing and the vertical hollow body.

15. The apparatus of claim 12 further comprising:
a set of variably sized wheel pads affixed to the drive bar; and,
a set of openings in the platform aligned with the wheel pads.

16. The apparatus of claim 12 further comprising a variably sized spacer wheel affixed to the rotor bar and frictionally engaged with the band.

17. The apparatus of claim 12 wherein the base is pivoted to a stored position so that the platform is generally parallel to the vertical hollow body.

18. The apparatus of claim 12 further comprising wherein the set of bolts rigidly affixing the chain stop to the chain and the vertical hollow body slide through the length of the slot between the first end and the second end.

19. A method of lifting and transporting a powered vehicle having a set of drive wheels with a transportation vehicle having a receiver, the method comprising:
providing a vertical housing connected to the receiver;
providing a chain housing telescopically engaged with the vertical housing;
providing a base pivotably connected to the chain housing;
providing a platform affixed to the base;
providing a rotor bar rotatably supported by the base;
providing a drive bar rotatably supported by the base;
providing a band engaged with the drive bar and the rotor bar;
providing a worm gear attached to the rotor bar;
providing a gear attached to the chain housing at a first end and having a set of teeth and a first sprocket, where the worm gear engages the set of teeth;
providing a chain engaged with the first sprocket and a second sprocket attached to the chain housing at a second end;
providing a chain stop rigidly affixed to the chain and to the vertical housing;
loading the powered vehicle on the platform;
securing the powered vehicle to the platform;
arranging the drive wheels adjacent the drive bar;
rotating the drive wheels in a first direction; and
raising the platform and the powered vehicle to a raised position.

20. The method of claim 19 further comprising pivoting the platform so that the platform is generally parallel to the vertical hollow body.
